(19) United States
(12) Patent Application Publication
(10) Pub. No.: US 2004/0042860 A1
(43) Pub. Date: Mar. 4, 2004

(54) Methods of simulating end-milling operations

(76) Inventor: Santosh Ranganath, Rochester Hills, MI (US)

Correspondence Address: KEITH J. MURPHY, CANTOR COLBURN LLP, 55 Griffin Road South, Bloomfield, CT, 06002, US

(21) Appl. No.: 10/228,569

(22) Filed: Aug. 27, 2002

(51) Int. Cl. B23C 1/00; B23Q 15/20

(52) U.S. Cl. 409/84

(57) ABSTRACT

A method of simulating a milling operation is provided. The method includes approximating the milling operation as a first two-dimensional representation; approximating the milling operation as a second two-dimensional representation; and computing a chip length. The first two-dimension representation is a first plane of intersection of a milling tool with a work piece. The second two-dimension representation is a second plane of intersection of the milling tool with the work piece. The chip length is computed from the first and second planes of intersection.

### TECHNICAL FIELD

This disclosure relates generally to end-milling. More specifically, this disclosure relates to methods of simulating end-milling operations.

### BACKGROUND

Many different machining methods have been developed. Machining as used herein is the act of removing material from a piece of stock material. Carving of a piece of wood into a desired shape is a basic or primitive form of machining. More complex machining methods include lathing and end-milling of materials such as, but not limited to, metals, plastics, ceramics, other materials and combinations of any of the foregoing. In the lathing process, a piece of stock material is rotated while a sharpened edge of a stationary tool is selectively applied to the rotating material. The edge of the tool removes material from the piece of stock to provide the desired shape.

End-milling operations consist of sweeping a rotating tool across a piece of stock material. The rotating tool includes a plurality of sharpened teeth or flutes that remove material from the stock. This process finds extensive use in the automotive, aerospace, tool, and die industries, because of its inherent flexibility in terms of tool paths/trajectories, and its ability to provide complex part features.

In order to predict variables of the end-milling operations (e.g., tool path, tool passes, and tool speed), models that capture the process kinematics have been developed. However, these models are limited in their application due to the restrictions on the part shape, tool shape and the tool path. For example, these models can have limited use when the tool is an insert-type tool where the teeth of the tool are not a single entity along a helix, but rather are a series of discrete tooth inserts that can be randomly positioned along the circumference of the tool.

Further, these models are limited due to the methods with which the model calculates the material removal rate. These prior methods can be both computationally intensive and time-consuming. It has also been found that these prior methods can have a less than desired accuracy.

Accordingly, there is a continuing need for easier and more accurate methods for simulating end-milling operations.

### SUMMARY

A method of simulating a milling operation is provided. The method includes approximating the milling operation as a first two-dimensional representation; approximating the milling operation as a second two-dimensional representation; and computing a chip length. The first two-dimensional representation is a first plane of intersection of a milling tool with a work piece. The second two-dimensional representation is a second plane of intersection of the milling tool with the work piece. The chip length is computed from the first and second planes of intersection.

A method of simulating an end-milling operation is provided. The method includes approximating a tool as a first polygon having two dimensions; approximating a work piece as a second polygon having two dimensions; intersecting the first polygon at a first position along a selected tool path of the endmilling operation with the second polygon to determine a first contact arc between the first and second polygons; representing a circumference of the tool as a two-dimensional area; defining a cutting window on the tool in the two-dimensional area, the cutting window having a first dimension equal to the first contact arc and a second dimension equal to a contact depth of the tool with the work piece; and determining a length of a chip by computing an intersection of one or more teeth of the tool with the work piece in the cutting window.

A method of simulating a milling operation is also provided which includes creating a first three-dimensional model of a tool and a second three-dimensional model of a work piece; defining a first plane through the first three-dimensional model of the tool to obtain a first polygon having two dimensions; defining the first plane through the second three-dimensional model of the work piece to obtain a second polygon having two dimensions; intersecting the first and second polygons with one another at a first position along a selected tool path; determining tool entry and exit points, the tool entry and exit points representing intersection points of the second polygon with the first polygon at the first position, the tool entry and exit points defining a first contact arc; approximating a circumference of the three-dimensional model of the tool as a two-dimensional area; defining a cutting window on the two-dimensional area, a first dimension of the cutting window being the first contact arc and a second dimension of the cutting window being a selected depth of the tool in the work piece; and plotting the tool entry and exit points in the cutting window to determine teeth entry and exit points, the teeth entry and exit points representing intersection points of teeth of the tool with the work piece at the first position, the tool entry and exit points defining a length of a chip.

The above-described and other features are appreciated and understood by those skilled in the art from the following detailed description, drawings, and appended claims.

### DESCRIPTION OF THE DRAWINGS

FIG. 1 is a schematic depiction of an end-milling operation;

FIG. 2 illustrates an exemplary embodiment of a method of simulating end-milling operations;

FIGS. 3-4 illustrate various exemplary embodiments of two-dimensional polygonal representations of a tool;

FIG. 5 illustrates an exemplary embodiment of a three-dimensional work piece;

FIG. 6 illustrates an exemplary embodiment of a two-dimensional polygonal representation of the work piece of FIG. 5;

FIG. 7 illustrates an exemplary embodiment of a first two-dimensional representation of an end-milling operation;

FIG. 8 illustrates a side view of an end-milling operation;

FIG. 9 illustrates an exemplary embodiment of a tool having its circumference approximated as a two-dimensional area;

FIG. 10 illustrates the forces predicted by the simulating method of FIG. 2 during an end-milling operation; and

FIG. 11 illustrates the forces measured during the end-milling operation simulated by FIG. 10.

### DETAILED DESCRIPTION

Referring now to the figures and in particular to FIG. 1, an end-milling operation 10 is illustrated. The end-milling operation 10 comprises sweeping a rotating end-mill tool 12 across a work piece 14. The tool 12 comprises a plurality of sharpened teeth or flutes 16 defined on a shaft or shank 18. The shank 18 is secured to a spindle 20 of a end-milling machine (not shown).

The milling machine is configured to rotate the tool 12 in a selected direction 22 with a selected speed, referred to herein as the spindle rate. The milling machine is also configured to move the tool 12 along a selected tool path 24 at a selected speed, referred to herein as the feed rate.

The work piece 14 is held in place on the milling machine while the tool 12 is moved along the tool path 24 such that the teeth 16 of the tool remove material, in the form of chips, from the work piece to form the desired part.

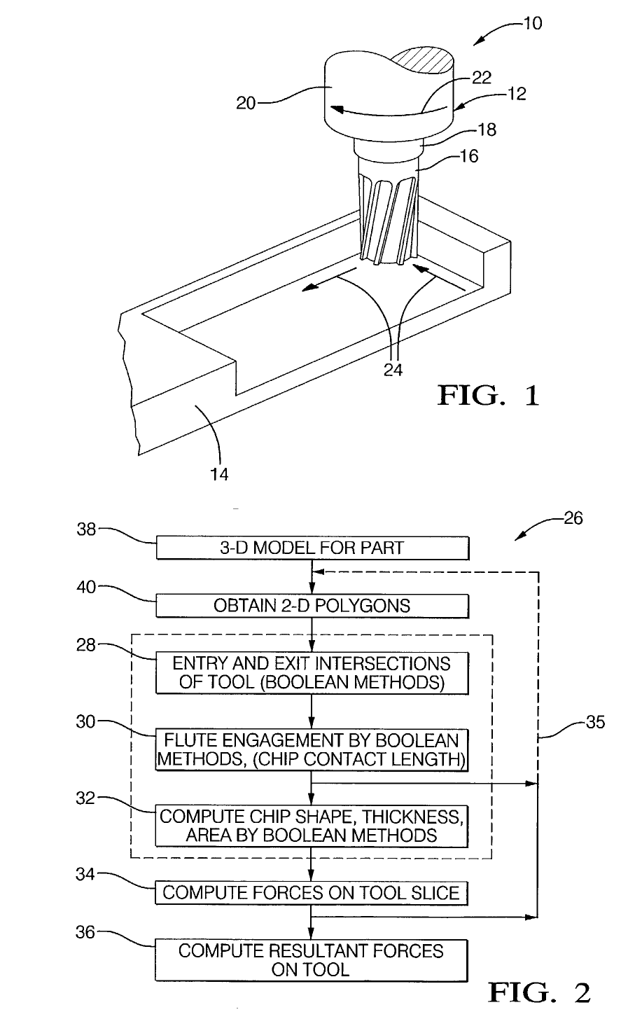

A method 26 of simulating an end-milling operations 10 is illustrated schematically in FIG. 2. Method 26 provides a simple means for simulating end-milling operations having two-dimensional tool paths (e.g., tool paths in directions normal to the axis of rotation of the tool), three-dimensional parts, and complex tool shapes (e.g., tools having cylindrical, spherical, fluted, insert-type tools, and other shapes). Specifically, the method uses a two-stage two-dimensional computation technique that uses a polygonal intersection computation to ensure accuracy with high computational speeds, and ease of processing and maintaining data.

Method 26 uses Boolean alegbra in conjunction with the two-stage two-dimensional computation to simulate the milling operation 10. Boolean algebra is defined as a set with two binary operations plus a unary operation. The binary operations are cumulative, associative, and each operation distributes over the other. The binary operations also require two identity elements that satisfy specific equations for all elements in the set. The two commutative binary operations can be described by any of various systems of postulates all of which can be deduced from the postulates that an identity element exists for each operation, that each operation is distributive over the other, and that for every element in the set there is another element which when combined with the first under one of the operations yields the identity element of the other operation.

The first stage 28 computes the region of contact (e.g., entry and exit) of the tool 12 into the work piece 14. The second stage 30 computes the length of the chip by determining the entry and exit of each tooth 16 of the tool 12 into the work piece.

These two stages 28 and 30 provide an accurate simulation of the resulting chip length. The chip shape, thickness, and area can be determined at node 32 from the length as will be described in detail herein. Once the area of the chip has been determined, the forces on the tool can be computed at nodes 34 and 36. Specifically, it has been deteremined that the forces on the tool are proportional to the chip area.

The forces on the tool can be used to determine the deflections in the tool during the end-milling process 10. By repeating the above computational method at every angular increment of the tool with respect to the work piece (illustrated as feedback loop 35 in FIG. 2), the forces and deflections can be determined for the entire tool path 24.

The quality of the part, such as the tolerance or variation from desired dimensions, that is formed by the end-milling operation 10 can be determined from these forces and deflections. Such simulations can also be useful in determining the amount of time necessary to produce a part from a particular end-milling operation.

Method 26 simulates the end-milling of three-dimensional parts using a plurality of readily available inputs. These inputs can include the shape of the tool 12, the shape of the work piece 14, the tool path 24, the material properties of the tool, the material properties of the work piece, and the end-milling parameters (e.g., the feed rate of tool, the spindle speed, etc.).

The three-dimensional shape of the tool 12 and the work piece 14 are developed at a node 38. Next, two-dimensional approximations of these components are determined at a node 40.

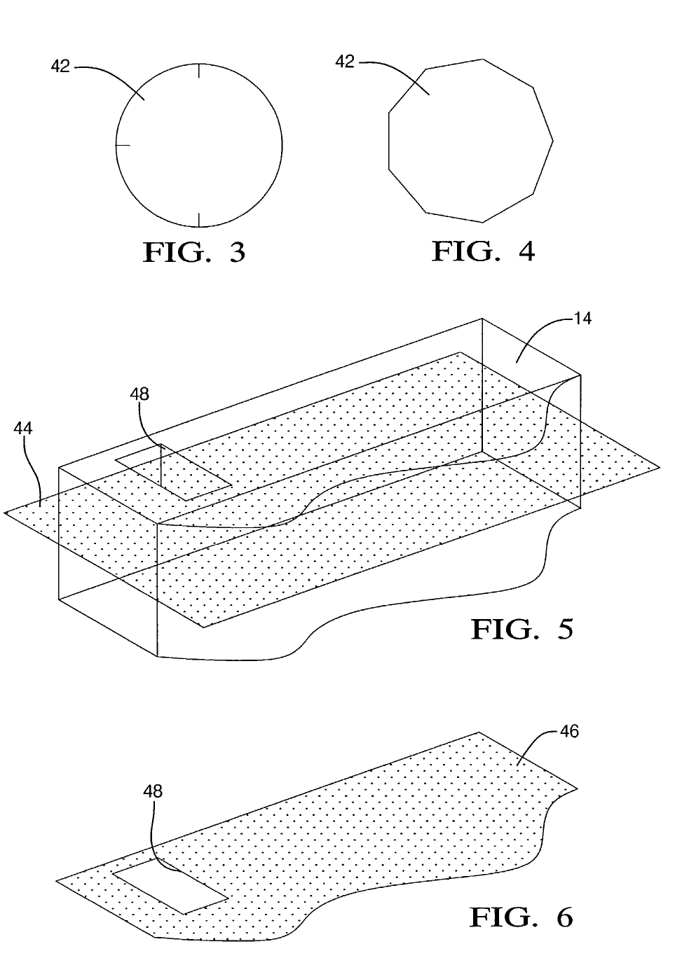

The portion of the tool 12 having the teeth 16 is approximated as a two-dimensional shape in FIGS. 3-4. This portion of the tool 12 can be approximated as a circular cross section, illustrated in FIG. 3. Alternately, this portion of the tool 12 can be represented as an n-sided polygon 42. Here, the number of sides “n” are a number sufficient to retain the accuracy of the computation. In the embodiment illustrated in FIG. 4, the tool 12 is approximated as a nine-sided polygon.

The three-dimensional shape of the work piece 14 is approximated as a two-dimensional shape by defining a cross-sectional plane 44 through the work piece 14 as illustrated in FIG. 5. In this manner, the workpiece 14 can also be represented as an n-sided polygon, where the number of sides “n” are a number sufficient to retain the accuracy of the computation. For example, the work piece 14 (FIG. 5) is approximated as a closed polygon 46 (FIG. 6).

As illustrated, the work piece 14 includes a preformed feature 48, which can include features molded or precut into the work piece prior to the milling operation 10.

It should be recognized that the work piece 14 is described above by way of example only as having one preformed feature 48 and as being taken along one plane 44. Of course, a number “m” of planes can be defined through the work piece at incremental depths along the axis of the tool to define multiple polygons. Here, the model is reduced to repeating the steps for the polygon 46 “m” number times (e.g., one for each plane) and combining the results. Additionally, more or less than one preformed feature can be defined in the work piece.

Thus, the three-dimensional tool and work piece are be simplified into two-dimensional polygons 42 and 46. The three-dimensional tool and work piece and the two-dimensional approximations can be provided by many commercial computer aided drafting or “CAD” software packages. For example, many CAD software packages, such as UniGraphics, IDEAS, ProE, KATIA, and others, can produce faceted representations of any three-dimensional model (e.g., an STL format). A cross section of this three-dimensional model can then be used to generate the required two-dimensional polygons. The two-dimensional approximation of the tool 12 (e.g., polygon 42) and the work piece 14 (e.g., polygon 46) are provided as an input to method 26 at node 40.

The tool 12 removes material in the form of chips from the work piece 14. The shape of a chip for any given instant of time can be determined by knowing which portions of the tool are interacting with the work piece at that given instant. The cross section of the chip can depend on the length of contact of the tool with the work piece, and the thickness or depth of the tool into the part.

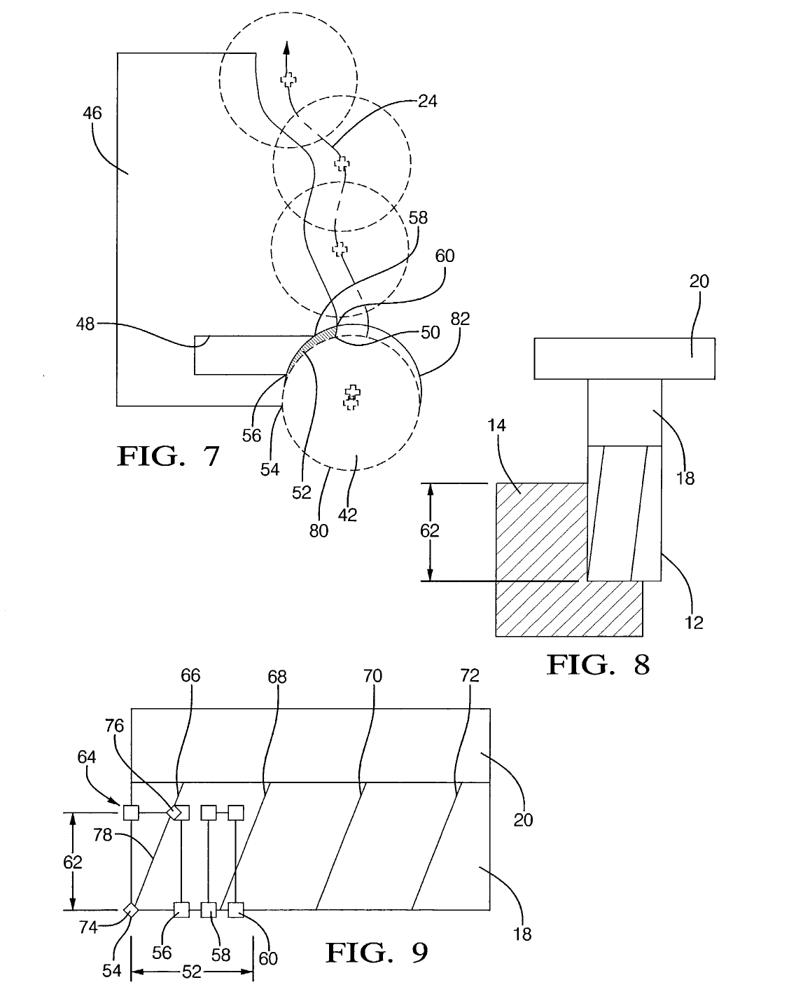

The first stage 28 determines region of contact between the tool and the work piece. The first stage 28 uses the inputs from nodes 38 and 40 to compute the entry and exit of the tool into the work piece. Specifically and with reference to FIG. 7, the method 26 simulates the movement of polygon 42 into the polygon 46 along the tool path 24. The intersection of the polygons at each position can be used to approximate a contact arc 50 of the tool with the work piece. Thus, the contact arc 50 is defined by the intersection of the polygons 42 and 46. This arc 50 can be used to determine the area of a chip 52 that is removed from the work piece.

It should be noted that the contact arc 50 is the intersection between the tool and the work piece. Of course, since the tool and the work piece are represented by polygons having “n” number of sides, the intersection may be a series of lines. Specifically, contact arc 50 may be a polyline defining the intersection of these polygons.

The first stage 28, by using Boolean alegbra, reduces the complex problem of determining the entry and exit points of the tool into the work piece to a simple problem of finding the intersections of a circle (e.g., the rotating polygon 42), and the polygon 46 to provide the contact arc 50. Here, the end-milling operation 10 is represented as a first two-dimensional representation defined as a first plane of intersection of the tool 12 and the work piece 14. The first plane is taken through plane 44.

In real end-milling operations, the input parameters to define the first plane can constantly change as the tool is moved across the part. In the exemplary embodiment, method 26 provides a means to determine first plane 44 as a function of time and distance. This allows method 26 to compensate for the dynamic nature of real world end-milling operations.

In the illustrated example, the polygon 42 enters the polygon 46 at point 54, but exits at point 56 where the arc 50 intersects the feature 48. The polygon 42 re-enters the polygon 46 at point 58, but exits at point 60. Thus, the arc 50 has two portions. The first portion of the arc is defined between points 54 and 56, and the seond portion is defined between points 58 and 60.

The first stage 28 computes the contact arc between the tool into the work piece by approximating the tool and work piece as two-dimensional polygons laid over one another. In the first stage 28, plane 44 simulates the three-dimensional end-milling process as a first two-dimensional representaion.

The area of the chip 52 also depends on the angular position of the teeth 16 with respect to the work piece 14. Thus, the second stage 30 computes the entry and exit points of the teeth into the work piece. Specifically, the point of entry of the teeth and the point of exit of the teeth is needed to determine the length of the chip 52. Description of the second stage 30 is made with reference to FIGS. 8 and 9.

The tool 12 is illustrated in FIG. 8 engaged with the work piece 14. During the end-milling operation 10, the tool 12 is positioned a selected depth 62 into the work piece 14. The arc 50 and the depth 62 define a cutting window 64 of the tool.

The cutting window 64 is best seen in FIG. 9, where the tool 12 is illustrated opened out along its circumference. Namely, the circumference of the tool is approximated as a two-dimensional rectangular area. The cutting window 64 is defined in this two-dimensional area to represent a second plane of intersection between the tool 12 and the work piece 14. The cutting window 64 therefore simulates the three-dimensional end-milling process in a second two-dimensional plane.

The tool 12 comprises four teeth 66, 68, 70, and 72, respectively, helically cut into the tool. The helix angle on the teeth 66-72 allow the teeth to come in contact and leave the work piece 14 as the tool 12 is rotated during the end-milling operation. Only the portions of each tooth 66-72 that lie within the cutting window 64 actually participate in the cutting and chip creation process. Accordingly, one or more of the teeth and/or one or more portions of each tooth may be entering or exiting the work piece in the cutting window at any given instant. When multiple portions of the teeth are in the cutting window at any given instant, each portion forms a segment of the chip 52. The chip 52 can therefore be an amalgamation of multiple chip segments, where multiple portions of the teeth are involved in creating the chip at the particlar instant.

The second stage 30 uses the entry and exit points of the tool 12 to determine the entry and exit points of the teeth 66-72. Namely, the second stage 30 plots the entry and exit points of the tool 12 determined by the the first stage 28 in the cutting window 64. Boolean alegbra is then used to determine the entry/exit points of the teeth 66-72.

In the illustrated example, the arc 50 covers about 75 degrees of the tool. Here, the first portion of the arc 50 covers from about zero degrees to about 20 degrees and the second portion covers from about 65 degrees to about 75 degrees. Tooth 54 is the only tooth that is engaged with the polygon 46 in the cutting window 64. Specifically, tooth 54 enters polygon 46 at point 74 and exits at point 76. Thus, tooth 54 is engaged with the polygon 46 from about 0 degrees to about 20 degrees. In this example, chip 52 is has only one chip segment due to the fact that only one portion of one tooth is engaged in the cutting window.

The length 78 of the chip is equal to the portion of the teeth that is in contact with the work piece. Thus in the illustrated example, the length 78 is the distance between points 74 and 76.

The shape, thickness, and area of chip 52 can be determined at node 32. Node 32 computes the chip 52 by comparing the polygon 42 in a first position 80 (in illustrated phantom) with respect to the polygon 46 and the polygon 42 in a second position 82 with respect to the polygon 46. The shape of the chip 52 is the area obtained by the intersection of polygon 46 with polygon 42 at the first position 80 as compared to the second position 82.

The thickness of the chip 52 is the distance between polygon 42 in the first and second positions. The position of the tool (both radially and along the tool path) in the first and second positions can be determined from the feed of the tool and the speed of the tool for a selected time-period. For example, the distance between the first position 80 and the second position 82 can be equal to the feed of the tool for the tooth. Feed per tooth of the cutter where the teeth are equispaced is given by feed per revolution divided by the number of teeth on the cutter.

The thickness of the chip 52 can vary along its length due to the helical configuration of the teeth. For example, when the teeth have a helix angle equal to zero, chip 52 has one chip segment. However, when the teeth have a helix angle other than zero, chip 52 comprises has multiple chip segments. In the example where chip 52 comprises one chip segment, the chip is substantially rectangular. In the example where chip 52 comprises multiple chip segments, each segment can be assumed to be substantially rectangular.

The rectangular chip shape allows node 32 to compute the area of the chip 52 as the product of the length 74 and the thickness of the chip. In this manner, node 32 can easily compute the chip area using two two-dimensional approximations of the tool 12 and the work piece 14. Here, the first of the two-dimensional approximations is represented by plane 44 (determined at the first stage 28) and the second of the two-dimensional approximations is represented by cutting window 64 (determined at the second stage 30).

The method 26 repeats nodes 28-32 for each incremental movement of polygon 42 with respect to polygon 46 along the tool path 24. By repeating nodes 28-32 of the computational method 26 at every angular increment of the tool along the tool path 24, the forces and deflections can be determined for the entire tool path at nodes 34 and 36. In alternate embodiments, method 26 can be repeated for “m” number times (e.g., one for each plane) and combining the results.

Node 34 determines the forces on each chip by assuming that the force is proportional to the chip area of that chip. Node 36 then sums the forces computed at node 34 to determine the resultant forces on the tool 12.

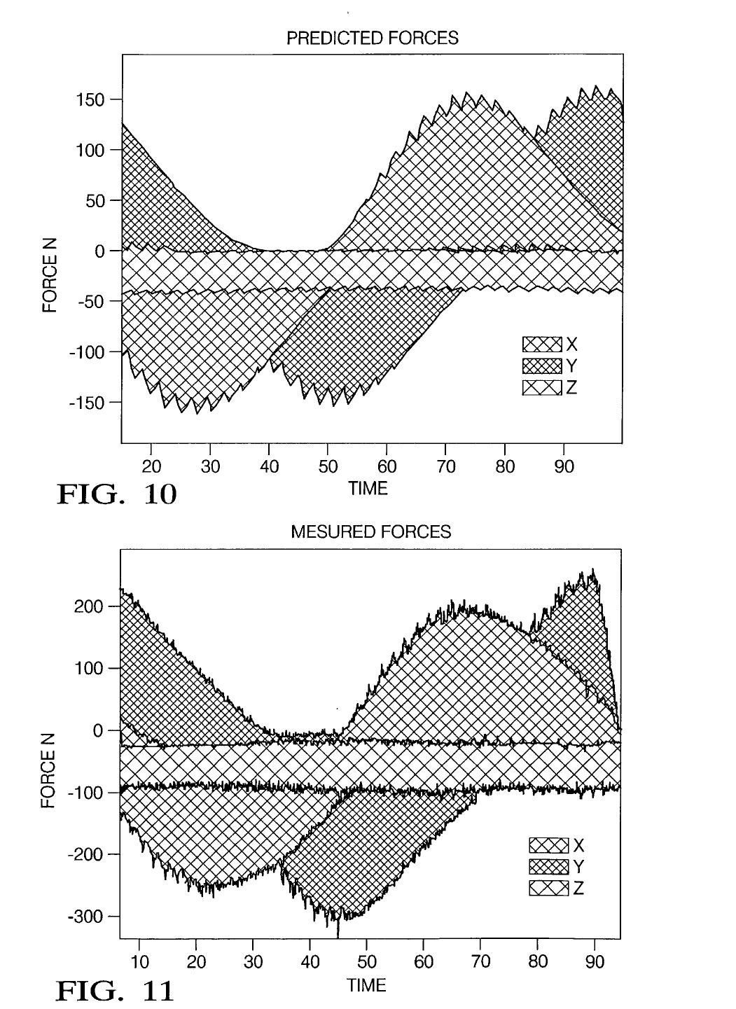

Turning now to FIGS. 10 and 11, a comparision of the forces predicted by method 26 as compared to forces measure for the same end-milling operation is illustrated. In this example, the work piece is formed of gray cast iron, and the tool is an untreated carbide tool. The tool has a 12.7 mm diameter, a 30 degree helix angle, and four teeth with zero rake angle. The tool was has a feed of 0.08 mm/rev (millimeters per revolution), was rotated at 1500 rpm (revolutions per minute). The x-direction is along the direction of the feed, the y-direction is normal to the feed, and the z-direction is through the axis of rotation of the tool. As can be seen in FIGS. 10-11, method 26 acurately and preceisely predicts the forces experienced during the end-milling operation.

Method 26 therefore computes the chip area, as well as the resulting force, for end-milling operations 10 of any three-dimensional workpiece and tool using a stack of multiple two-dimensional polygons, along a two-dimensional tool path.

Method 26 computes a chip area from a three-dimensional end-milling operation in two stages. The first stage uses polygonal intersections to compute the intersection between the tool and work piece. The first stage also computes the resultant part shape due to the removal of the chip. The second stage computes tooth entry exit angles into the work piece to determine the length of the chip. The result of the two stages is the chip shape and area. Boolean algebra is used to determine the polygon intersections without loss of accuracy or computational efficiency.

Method 26 allows workpieces and tools having any shape to be approximated as two-dimensional polygons, and uses Boolean intersections of these two polygons to compute the chip shape.

It should be recognized that the tool 12 is illustrated therein by way of example only. Of course, a tool having more or less than four teeth, a tool with or without helical teeth, a tool having an arc that covers more or less than 75 degrees, and others are contemplated to be with in the scope of the present disclsoure.

It should also be noted that the terms “first”, “second”, and “third” may be used herein to modify elements performing similar and/or analogous functions. These modifiers do not imply a spatial, sequential, or hierarchical order to the modified elements, unless otherwise indicated.

While the invention has been described with reference to one or more an exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of simulating a milling operation, comprising:
approximating the milling operation as a first two-dimensional representation, said first two-dimension representation being defined as a first plane of intersection through a milling tool with a work piece;
approximating the milling operation as a second two-dimensional representation; said second two-dimension representation being defined as a second plane of intersection of said milling tool with said work piece; and
computing a chip length from said first and second planes of intersection.

2. The method as in claim 1, further comprising:
moving said tool with respect to said work piece along a selected tool path from a first position to a second position; and
comparing said first plane of intersection at said first position to said first plane of intersection at said second position to determine a chip thickness.

3. The method as in claim 2, wherein comparing said first plane of intersection at said first position to said first plane of intersection at said second position also determines a chip shape.

4. The method as in claim 3, wherein said chip shape is formed from a chip segment or an amalgamation of chip segments.

5. The method as in claim 4, wherein said chip segment has a shape that is substantially rectangular.

6. The method as in claim 3, further comprising:
calculating a chip area from said chip shape, said chip length, and said chip thickness.

7. The method as in claim 6, further comprising:
computing a force on said milling tool, said force being proportional to said chip area.

8. A method of simulating an end-milling operation, comprising:
approximating a tool as a first polygon having two dimensions;
approximating a work piece as a second polygon having two dimensions;
intersecting said first polygon at a first position along a selected tool path of the end-milling operation with said second polygon to determine a first contact arc between said first and second polygons;
representing a circumference of said tool as a two-dimensional area;
defining a cutting window on said tool in said two-dimensional area, said cutting window having a first dimension equal to said first contact arc and a second dimension equal to a contact depth of said tool with said work piece; and
determining a length of a chip by computing an intersection of one or more teeth of said tool with said work piece in said cutting window.

9. The method as in claim 8, further comprising:
moving said tool with respect to said work piece along said selected tool path from said first position to a second position;
intersecting said first polygon at said second position with said second polygon to determine a second contact arc between said first and second polygons; and
determining a thickness of said chip by comparing said first and second contact arcs to one another.

10. The method as in claim 9, wherein moving said tool with respect to said work piece along said selected tool path is repeated until said tool moves through said selected tool path.

11. The method as in claim 9, further comprising:
determining an area of said chip thickness by comparing said first and second contact arcs to one another.

12. The method as in claim 9, wherein said thickness is sufficiently small to cause said chip to have a substantially rectangular shape.

13. The method as in claim 9, further comprising:
calculating an area of said chip from said length and said thickness.

14. The method as in claim 12, further comprising:
computing a force on said end-milling tool, said force being proportional to said area.

15. A method of simulating an end-milling operation, comprising:
creating a first three-dimensional model of a tool and a second three-dimensional model of a work piece;
defining a first plane through said first three-dimensional model to obtain a first polygon having two dimensions;
defining said first plane through said second three-dimensional model to obtain a second polygon having two dimensions;
intersecting said first and second polygons with one another at a first position along a selected tool path;
determining tool entry and exit points, said tool entry and exit points representing intersection points of said first and second polygons at said first position, said tool entry and exit points defining a first contact arc;
approximating a circumference of said three-dimensional model of said tool as a two-dimensional area;
defining a cutting window on said two-dimensional area, a first dimension of said cutting window being said first contact arc and a second dimension of said cutting window being a selected depth of said tool in said work piece; and
plotting said tool entry and exit points in said cutting window to determine teeth entry and exit points, said teeth entry and exit points representing intersection points of teeth of said tool with said work piece at said first position, said tool entry and exit points defining a length of a chip.

16. The method as in claim 15, wherein said tool and said teeth entry and exit points are determined using Boolean algebra.

17. The method as in claim 16, further comprising:
intersecting said first and second polygons with one another at a second position along said selected tool path;
determining second tool entry and exit points, said second tool entry and exit points representing intersection points of said second polygon with said first polygon at said second position, said second tool entry and exit points defining a second contact arc; and
determining a thickness of said chip by comparing said first and second contact arcs to one another.

18. The method as in claim 17, further comprising:
determining an area of said chip from said thickness and said length.

19. The method as in claim 17, wherein a force on said tool is proportional to said area.

20. The method as in claim 18, wherein said first and second polygons are intersected with one another at a plurality of positions along said selected tool path such that said force on said tool is determined along said selected tool path.
